(19) United States
(12) Patent Application Publication
(10) Pub. No.: US 2025/0381997 A1
(43) Pub. Date: Dec. 18, 2025

(54) Collapsible Bellman Cart Assembly

(71) Applicant: Royal Basket Trucks, Inc., Darien, WI (US)

(72) Inventors: John K. Armfield, Edgerton, WI (US); Brian Albrecht, Elkhorn, WI (US); Tanner Wik, Menomonie, WI (US); Paharo Orr, Wauwatosa, WI (US)

(21) Appl. No.: 19/240,171

(22) Filed: Jun. 17, 2025

Related U.S. Application Data
(60) Provisional application No. 63/661,118, filed on Jun. 18, 2024.

(51) Int. Cl. B62B 3/02

(52) U.S. Cl. CPC B62B 3/02; B62B 2205/20; B62B 2301/044

(57) ABSTRACT

A rollable luggage and garment cart assembly that is adjustable between an in-use configuration and a stowed configuration. The cart assembly includes a deck having a pivotable door disposed between respective end portions of the deck. A cage assembly extends upwardly from the deck and includes a garment rail that extends between respective end portions of the cage assembly and is pivotable secured to one end portion of the cage assembly and removably cooperates with the other end portion of the cage assembly. When the garment rail is disengaged from one end portion of the cage assembly and rotated relative to the second end portion, and the pivotable door of the deck is rotated out of alignment with the end portions of the deck, the end portions of the deck can be translated toward one another to manipulate a spatial footprint of the cart assembly.

### CROSS REFERENCE TO RELATED APPLICATIONS

This application claims priority to U.S. Provisional Patent Application Ser. No. 63/661,118 filed on Jun. 18, 2024 titled “Collapsible Bellman Cart Assembly” and the disclosure of which is expressly incorporated herein.

### FIELD OF THE INVENTION

The present invention relates generally to combined garment and luggage transport cart assemblies-commonly referred to as bellman carts, and more particularly, to a bellman cart assembly that is constructed to be collapsible such that the cart assembly can achieve a respective in-use configuration and, when not in use, can achieve a stowed configuration.

### BACKGROUND OF THE INVENTION

Many hospitality environments such as hotels, resorts, and the like rely on the comings and goings of tenants or guests for stays of variable durations. Many guests, regardless of the duration or intended activities undertaken during a stay, travel with various personal items including luggage, briefcases, hanging garment bags or the like. During reception, check-in, and check-out activities, to make guests stay as comfortable as possible, many establishments maintain a fleet of rolling bellman or luggage carts that are employed to facilitate the efficient and expedient transfer of guests and their baggage to and from their respective quarters. While some facilities provide rolling carts intended to transport luggage, such devices occasionally omit consideration for the transport of loose garment bags in the desired hanging orientation to protect the appearance of the garments contained therein. Still others provide rolling luggage carts that include a garment rack but which can be easily overloaded and can be more susceptible to tipping as guests and/or staff navigate the carts from the commonly more open reception areas through more confined spaces associated with hallways, intersections, and floor transitions such as those common to door and elevator entries and the like.

Whereas others provide luggage carts having a more robust or stout construction to mitigate instances of tipping, such assemblies detract from efficient utilization of facility spaces. Many facilities maintain a fleet of carts and a number of carts in that fleet sufficient to accommodate heavy periods of usage experienced during more customary holiday or vacation times, tradeshow events, and/or vessel arrival events customary to resort type operations. Although most facilities would prefer a fleet of carts sufficient to accommodate transient periods of heavy usage, many facilities maintain fewer carts than would be preferred due to concerns for providing suitable secured storage of the carts when not in use during lulls in check-in/check-out operations. Commercially available bellman carts that accommodate transport of both hanging garments and luggage or baggage are provided in a fixed shape and with a generous width and length to accommodate suitcases and the like. Such carts are also commonly provided with a generally robust and open expanded construction such that achieving overlapping or stacked configurations of the carts during storage is rendered impractical if not impossible. Maintaining a fleet of luggage, baggage, and garment transport carts requires facilities that employ such devices maintain a large securable space simply to accommodate storage or a majority of the available fleet of bellman carts during non-usage of the respective carts.

Accordingly, there is a need to provide a luggage cart assembly that is constructed to accommodate rolling transport of luggage and baggage as well as hanging garments, has a robust construction that facilitates repeated loading, unloading, and rolling transport of the assembly, and can be expeditiously and intuitively adjusted between an in-use configuration and a stowed configuration that is more compact than in-use configurations.

### SUMMARY OF THE INVENTION

The present invention provides numerous advantages over the prior art. The present invention provides a rolling collapsible luggage transport cart assembly that is defined by a platform constructed to support luggage or bagged materials, a garment rail constructed to support hanging goods, and is adjustable between an in-use or deployed configuration and a stowed or collapsed configuration that provides a compact configuration of the respective luggage cart assemblies. The assembly is further constructed to avoid or mitigate tippage of the cart assembly whether oriented in the expanded or contracted configurations.

One aspect of the present application that is usable or combinable with other features, aspects, or objects of the present application discloses a bellman cart assembly that includes a deck having a first end portion, a second end portion, and a center portion that is pivotably connected to a respective one of first end portion and the second end portion of the deck. A tube assembly extends in a generally upward direction from each of the first end portion and the second end portion of the deck. A garment rail extends between the tube assembly associated with the first and second end portions of the deck. A plurality of casters are secured to the deck and generally disposed under a respective one of the first end portion and the second end portion thereof. A hinge arrangement is connected between the center portion of the deck and the respective one of the first end portion and the second end portion such that the center portion is selectively rotatable relative thereto. A first guide rail is attached to the first end portion and a second guide rail is attached to the second end portion such that the first guide rail and the second guide rail are slidable relative to one another to allow translation of the first end portion of the deck relative to the second end portion of the deck to manipulate a distance therebetween. A spring piston is connected between the center portion of the deck and the respective one of the first end portion and the second end portion and configured to bias the center portion out of alignment with the first end portion and the second end portion of the deck, such that, when the center portion of deck is disposed out of alignment with the first and second end portions of the deck, the deck is compressible to reduce a footprint of the bellman cart assembly when storage thereof is desired.

Another aspect of the present application that is usable or combinable with one of the more of the other features, aspects, or objects disclosed a method of forming a collapsible bellman cart assembly. The method includes providing a deck that is defined by a first end portion, a second end portion, and a center portion that is pivotably connected to the first end portion. A cage assembly is provided that is defined by a first cage end that extends from the first end portion of the deck, a second cage end that extends from the second end portion of the deck, and a garment rail that extends between the first cage end and the second cage end and is pivotable relative to the first cage end and removably cooperates with the second cage end. A rail assembly is provided that connects the first end portion of the deck to the second end portion of the deck such that the first end portion of the deck and the second end portion of the deck are movable between respective extended and retracted positions relative to one another. When the garment rail is removed or disengaged from the second cage end and subsequently pivoted relative to the first cage end; and the center portion of the deck is pivoted out of alignment with the first end portion and the second end portion of the deck; the first and second end portions of the deck are rendered translatable relative to one another such that the bellman cart assembly can achieve respective extended and retracted positions.

A further aspect of the application that is useable or combinable with one or more of the above features, objects, or aspects discloses a bellman cart assembly having a deck assembly that is defined by respective opposing end portions and a center portion that is pivotably connected to a respective one of the opposing end portions. A respective tube assembly extends in a generally upward direction from each of the respective opposing end portions of the deck assembly and a garment rail extends between the respective tube assemblies. The garment rail is pivotably connected to one of the respective tube assemblies and selectively removable and securable to the other of the respective tube assemblies. A plurality of casters are secured to the deck assembly and extend in a direction opposite the respective tube assemblies and facilitate rolling transport of the bellman cart assembly during both use and storage operations. A hinge connects the center portion of the deck assembly to the respective one of the opposing end portions to which the center portion is pivotably connected. A rail assembly is secured to the deck assembly and operable to adjust a distance between the respective opposing end portions of the deck assembly and a biasing device is connected between the center portion of the deck assembly and a respective one of the opposing end portions to bias the center portion out of alignment with the opposing end portions of the deck assembly when storage or non-use of the bellman cart assembly is desired.

These and other aspects, objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications. Other features, objects, aspects, and advantages of the invention are made apparent from the following description taken together with the drawings. It is further appreciated that the various features, aspects, objects, and advantages disclosed above are not mutually exclusive to the specific aspects of the invention such that the various discrete features, aspects, objects, and advantages are usable and/or combinable with one another.

### DESCRIPTION OF THE DRAWINGS

The drawings illustrate the best mode presently contemplated of carrying out the invention.

In the drawings:

FIG. 1 is a perspective view of a collapsible bellman cart assembly according to the present invention and oriented in an in-use or deployed configuration;

FIG. 2 is an end elevation view of the collapsible bellman cart assembly shown in FIG. 1;

FIG. 3 is a front elevational view of the collapsible bellman cart assembly shown in FIGS. 1 and 2;

FIG. 4 is a top plan view of the collapsible bellman cart assembly shown in FIGS. 1-3;

FIG. 5 is a perspective view of a garment rail assembly of the bellman cart assembly shown in FIGS. 1-4;

FIG. 6 is a cross-section view of the garment rail assembly shown in FIG. 5 taken along line 6-6 shown in FIG. 4;

FIG. 7 is a perspective view from below the collapsible bellman cart assembly shown in FIG. 1;

FIG. 8 is a bottom plan view of the collapsible bellman cart assembly shown in FIG. 1;

FIG. 9 is a perspective view of above the collapsible bellman cart assembly shown in FIG. 1 with a cage, garment rail, and deck panels removed therefrom and exposing a slide or rail assembly disposed thereunder;

FIG. 10 is a bottom side perspective view of a portion of the collapsible bellman cart assembly shown in FIG. 1 and shows a pivotable connection between a center section of the deck assembly and a respective end section thereof;

FIG. 11 is a cross-section elevation view of a portion of the collapsible bellman cart assembly shown in FIG. 10 taken along line 11-11 shown in FIG. 8;

FIG. 12 is a view similar to FIG. 11 of a cross-section elevation view of the deck portion of the collapsible bellman cart assembly shown in FIG. 1 taken along line 12-12 shown in FIG. 8;

FIG. 13 is a perspective view of a stowed orientation latch assembly of the collapsible bellman cart assembly shown in FIG. 1;

FIG. 14 is a perspective view of a deployed orientation latch assembly of the collapsible bellman cart assembly shown in FIG. 1;

FIG. 15 is a lower perspective view of the collapsible bellman cart assembly shown in FIG. 1;

FIG. 16 is a perspective view of the collapsible bellman cart assembly shown in FIG. 1 and the bellman cart assembly oriented in a stowed configuration;

FIG. 17 is a top plan view of the collapsible bellman cart assembly shown in FIG. 16 in the stowed orientation;

FIG. 18 is a side elevation view of a portion of the collapsible bellman cart shown in FIGS. 16 and 17 with a stowed orientation latch assembly securing the respective end portions of the deck assembly relative to one another with the center portion of the deck assembly oriented in an upward extending direction therefrom;

FIG. 19 is a side perspective view of the collapsible bellman cart assembly shown in FIG. 15 with one side of the cage and a plurality of casters removed therefrom;

FIG. 20 is a bottom plan view of the portion of collapsible bellman cart assembly shown in FIG. 19 and with the other slide guide rails removed therefrom; and

FIG. 21 is a side perspective view of the portion of the collapsible bellman cart assembly shown in FIG. 19 with the collapsed orientation latch assembly engaged with the catch associated with the opposing end of the deck assembly.

Various aspects of the invention are described in detail with reference to the drawings, wherein like reference numerals, including the reference numeral designations, represent like parts and assemblies throughout the several views. Reference to one embodiment does not limit the scope of the claims attached hereto. Additionally, any examples set forth in this specification are not intended to be limiting and merely set forth some of the many possible embodiments for the appended detailed description and claims.

### DETAILED DESCRIPTION OF THE PREFERRED EMBODIMENT

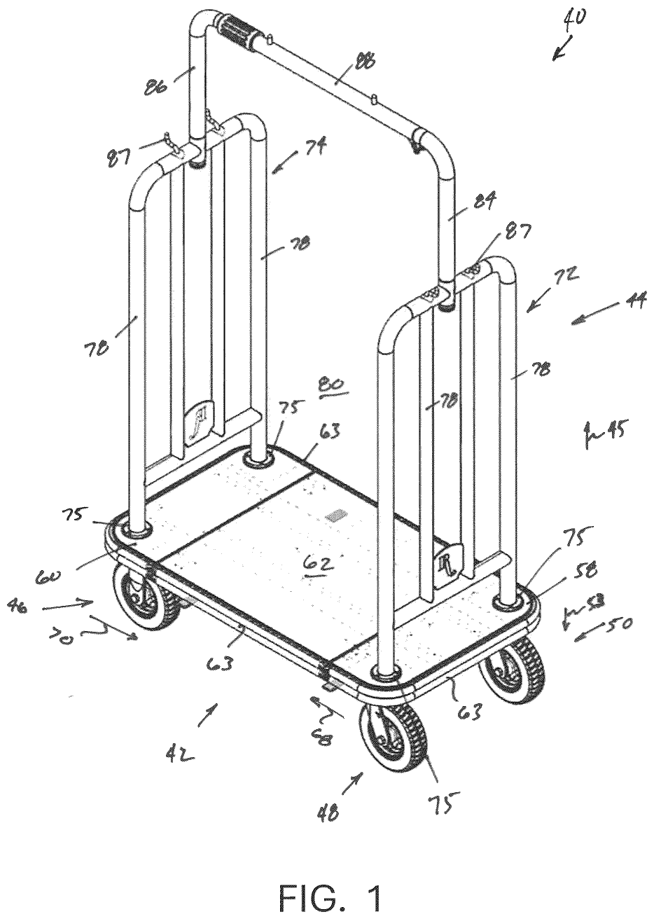

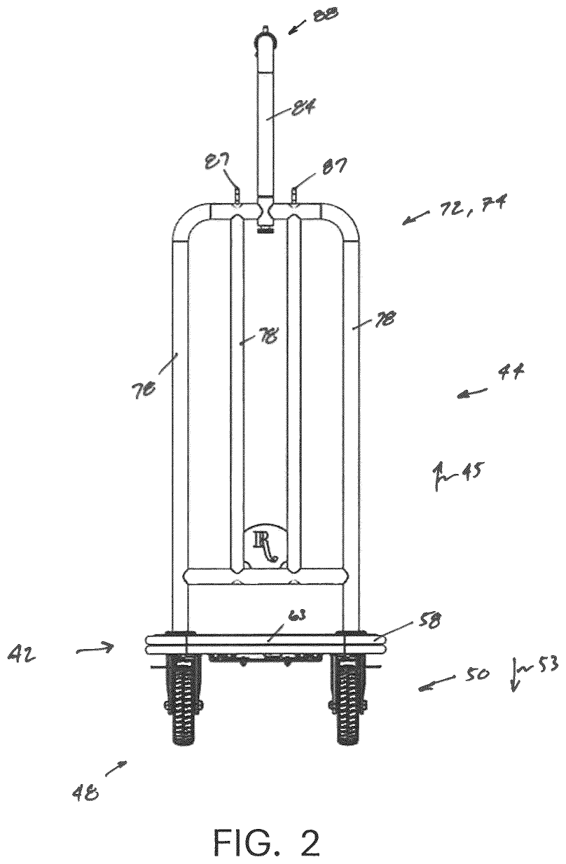

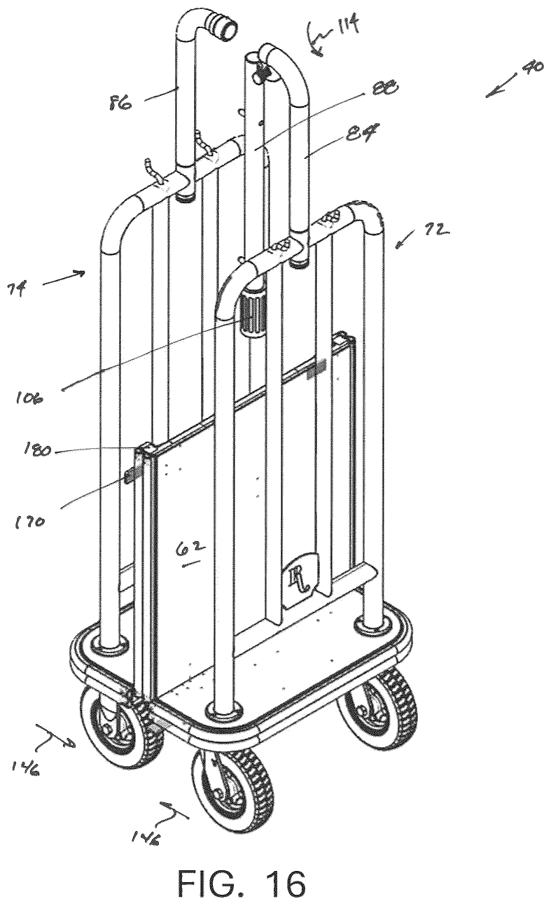

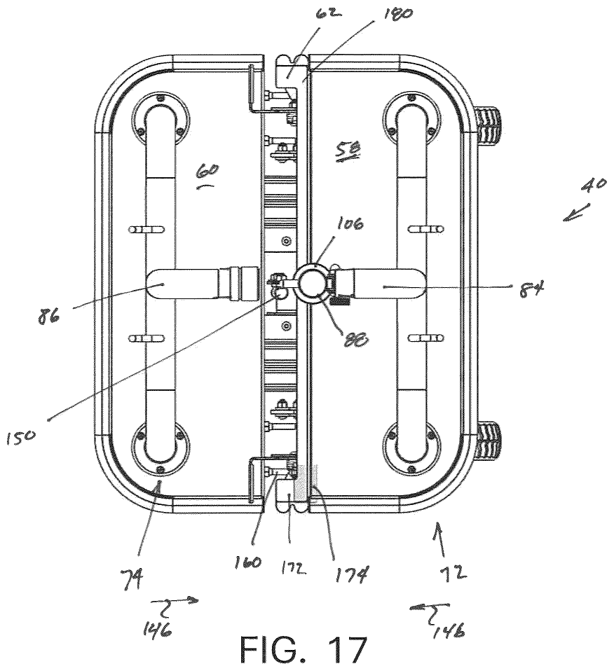

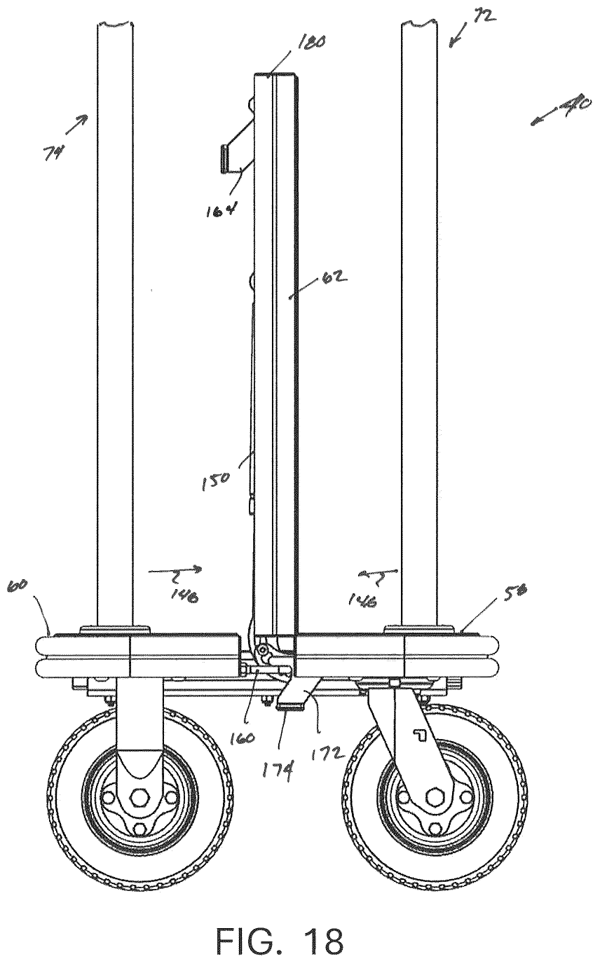

The present invention discloses a luggage and garment transport cart assembly or bellman cart assembly and method of providing or forming a bellman cart assembly 40 that is adjustable or collapsable between an in-use or deployed configuration (as shown in FIGS. 1-4) and a stored, stowed, or collapsed configuration (as shown in FIGS. 16-18) wherein the bellman cart assembly occupies a considerably smaller footprint or spatial area than when oriented in the deployed configuration. When in the deployed configuration, bellman cart assembly 40 provides rollable transport of both luggage and hangable items such as garment cases or the like. As disclosed further below, the configuration of bellman cart assembly 40 shown in FIGS. 1-4 represents an in-use configuration of bellman cart assembly 40 wherein the bellman cart assembly 40 is configured to support both luggage or baggage upon a bed or deck thereof and hanging goods such as attaché cases or hangable garment bags or the like generally thereabove. Comparatively, FIGS. 16-18 show bellman cart assembly 40 when configured in a collapsed or stowed configuration wherein bellman cart assembly 40 occupies a smaller footprint or area occupied by bellman cart assembly 40 than when the bellman cart assembly is oriented in the in-use configuration.

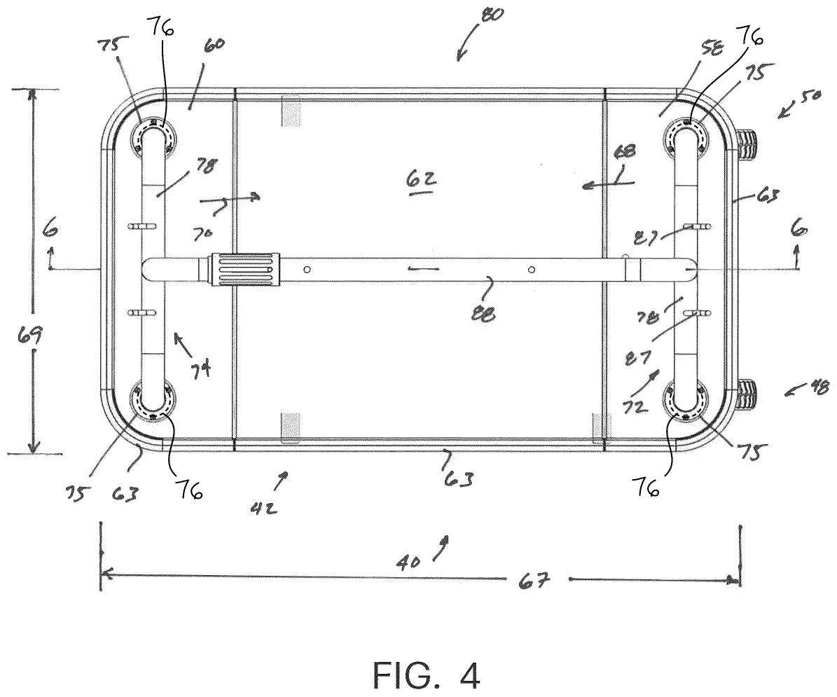

Referring to FIGS. 1-4, bellman cart assembly 40 includes a base, chassis, deck, or deck assembly 42; a cage assembly 44 that extends in a generally upward direction, indicated by arrow 45, from deck assembly 42; and a plurality of wheels or caster assemblies 46, 48, 50, 52 that extend in a generally downward direction, indicated by arrow 53, from deck assembly 42 and which facilitate rollable transport of bellman cart assembly 40. Deck assembly 42 includes a first deck end portion 58 and a second end portion 60 that are disposed at generally opposite longitudinal ends of bellman cart assembly 40 and which are movable relative to one another as disclosed further below. As shown in FIG. 4, the longitudinal length of bellman cart assembly 40 is indicated by dimension line 67 and a lateral dimension of bellman cart assembly 40 is indicated by dimension line 69 when bellman cart assembly 40 is oriented in an in-use configuration as shown in FIGS. 1-4 and collectively define the in-use horizontal plane, a plan view, or footprint associated with use thereof. As disclosed further below, when oriented in the stowed or stored configuration, although dimension 69 remains the same, dimension 67 can be varied to provide a smaller spatial area associated with storage or non-use of bellman cart assembly 40.

A door or center portion 62 of deck assembly 42 is disposed between the respective first and second deck end portions 60, 62 and is rotationally or pivotably connected to one of end portions 58, 60 and selectively securable to the opposing respective end portion 58, 60. The movable nature of deck center portion 62 contributes to the selective translation of respective end portions 58, 60 of deck assembly 42 toward one another during storage of bellman cart assembly and away from one another to effectuate deployment or use thereof in the orientation shown in FIGS. 1-4. Each of the respective portions of deck assembly 42 preferably include bumpers or scuff guards 63 associated with the outermost radial edges or portions thereof to mitigate damage and/or marring of environment surfaces attributable to incidental contact with bellman cart assembly 40. As alluded to above, rotation of center portion 62 of deck assembly 42 out of plane with respective deck first and second end portions 58, 60 allows respective end portions 58, 60 of deck assembly 42 to be translated toward one another, as indicated by arrows 68, 70 when storage or collapsing of bellman cart assembly 40 desired.

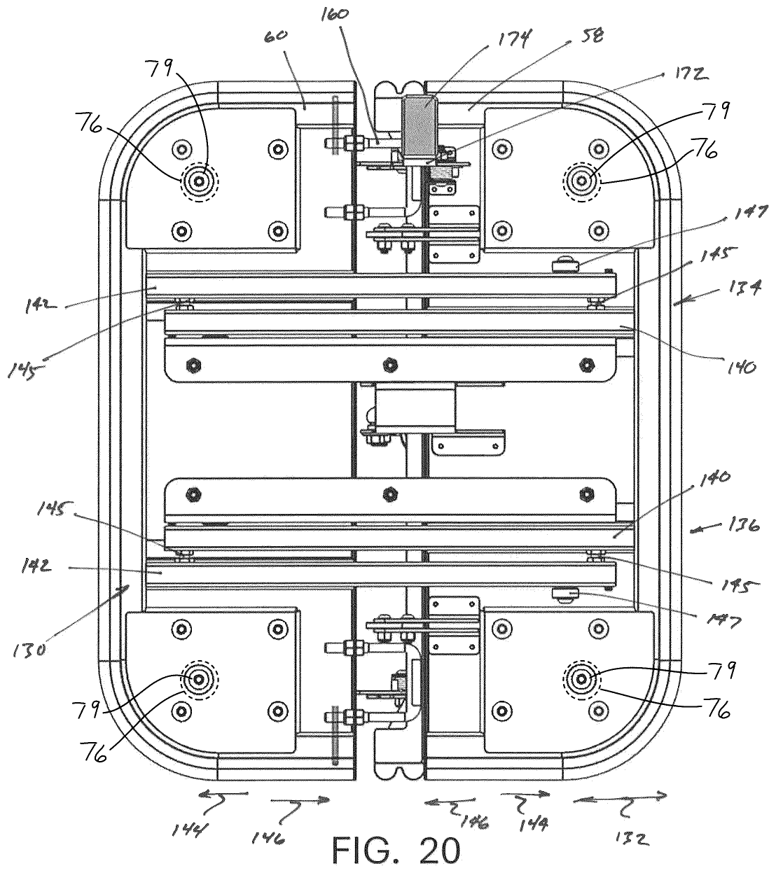

Still referring to FIGS. 1-4, cage assembly 44 includes a first cage end portion 72 that is attached to first deck end portion 58 of deck assembly 42 and a second cage end portion 74 that is attached to second deck end portion 60 of deck assembly 52. In a preferred aspect, respective aesthetic trim rings or escutcheons 75 cover joints between cage end portions 72, 74 and respective first and second deck end portions 58, 60. The joints are provided by engagements between respective ends of cage end portions 72, 74 and mount sockets 76 (FIGS. 4 and 20). Mount sockets 76 are secured to the first and second deck end portions 58, 60 and have cup-like configurations with upwardly facing receptacles bounded by circumferential sidewalls that concentrically receive the ends of cage end portions 72, 74. Mount sockets 76 have bottom walls as stops that engage the ends of the end cage end portions 72, 74, providing support from below. Fasteners 79 (FIG. 20), which may be screws, bolts, or the like, extend through central bores of the mount socket 76 bottom walls to connect the ends of end cage end portions 72, 74 to the mount sockets 76. This is typically done by threaded engagement of the fasteners 79 (FIG. 20) with screw bosses in the ends of the end cage end portions 72, 74 . . . . Respective cage end portions 72, 74 are defined by a plurality of tubes 78 that generally define a luggage cavity 80 therebetween. Each cage end portion 72, 74 includes an upwardly extending stem 84, 86 such that cage assembly 44 includes a garment rail 88 that is movably connected to the respective stems 84, 86 of respective cage end portions 72, 74. In a preferred aspect, one of more optional wire form garment hooks 87 can be secured to cage assembly 44. Although garment hooks 87 are shown as extending in an outward hanging direction, it should be appreciated that garment hooks 87 could be configured to extend in a laterally inboard direction. Regardless of the relative orientation, garment hooks 87 are configured to support strapped packaging or garments in a hanging orientation and/or wherein the respective hanging transported goods can be oriented inboard or outboard of the respective cage end portions 72, 74.

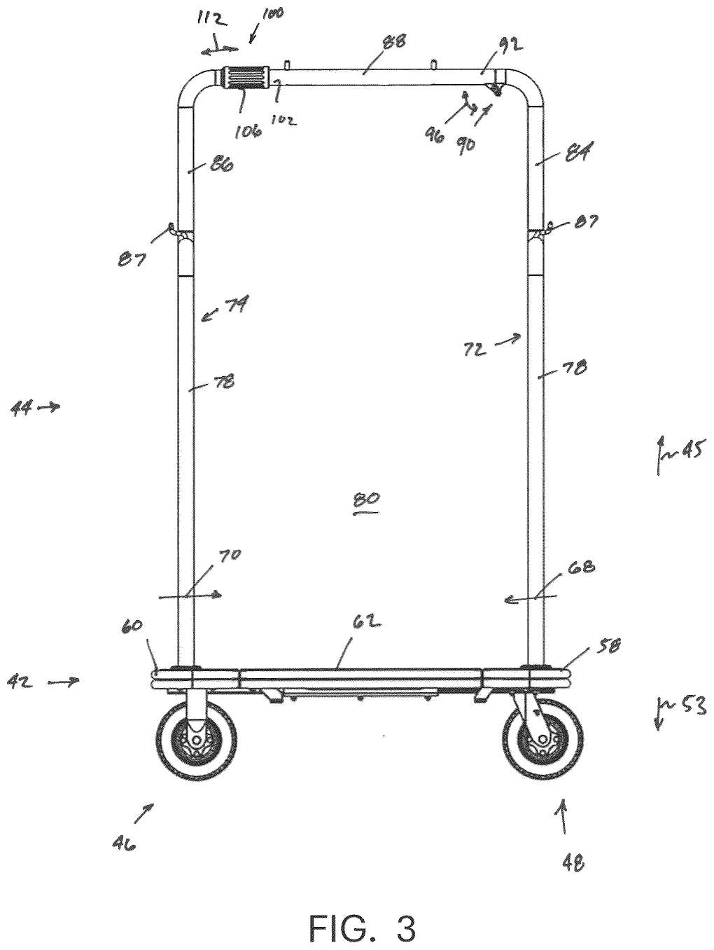

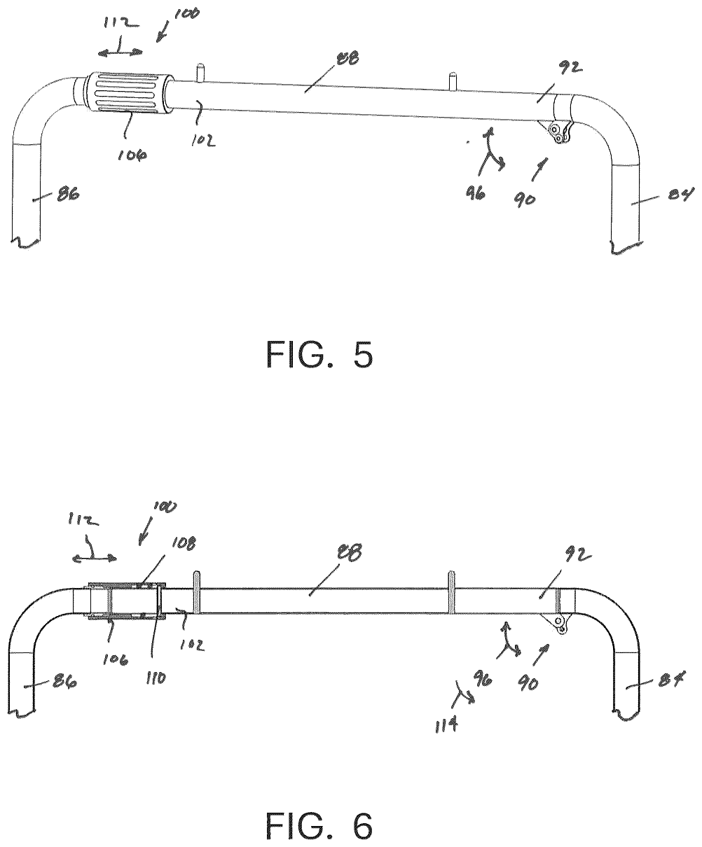

Referring to FIGS. 3, 5, and 6, a pivot assembly 90 attaches a first end 92 of garment rail 88 to stem 84 such that garment rail 88 is rendered selectively rotatable relative thereto, as indicated by arrow 96, to manipulate the configuration of bellman cart assembly 40 between the in-use and stowed configurations. That is, garment rail 88 is rotatable in a generally downward direction when storage of bellman cart assembly 40 is desired and rotatable in a generally upward direction to extend toward the opposing cage end portion 74 when deployment or use of bellman cart assembly 40 is desired. A latch assembly 100 cooperates with second end 102 of garment rail 88 and selectively engages stem 86 when garment rail 88 is oriented for use of supporting hanging goods and bellman cart assembly 40 is oriented in the deployed configuration.

As shown in FIG. 6, latch assembly 100 includes an operator 106, an optional biasing device 108, and a post 110 that collectively facilitate slideable operation of operator 106 relative to garment rail 88 such that operator 106 can selectively engage stem 86. Operator 106 is slidable in direction 112 relative to garment rail 88 to allow selective engagement and disengagement of operator 106 from stem 86 when desired. Disengagement of operator 106 from stem 86 allows movement of garment rail 88 relative to stem 84 via operation of pivot assembly 90. Engaged and disengaged states of latch assembly 100 can be achieved in a variety of ways through cooperating interactions of respective segments of operator 106 and stem 86 that facilitate their secure but separable mechanical connection with each other. Axial translation, such as sliding of operator 106, may provide a coupling overlap with stem 86. Further mechanical connection may be defined through rotational movement of operator 106, for example, through threaded engagement with stem 86. It is understood that the mechanical connection may instead be achieved through press or friction type surface engagement(s). For example, an end of stem 86 may include a resilient bushing(s) that compresses when operator 106 slides over it, with the bushing's restorative force resisting unintentional sliding withdrawal of operator 106 from stem 86. Optionally, operator 106 is spring loaded or spring biased to an extended position to facilitate the releasable connection between operator 106 and stem 86. In such an implementation, user retraction of operator 106 along garment rail 88 against the bias of spring 108 and subsequent alignment of garment rail 88 between the upward oriented ends of stems 84, 86 allows operator 106 to be selectively engaged with stem 86 such that garment rail 88 is oriented in a generally secure horizontal orientation and defines an upper boundary of luggage cavity 80. When operator 106 is aligned with stem 86, and the user releases operator 106, spring 108 biases operator 106 into slideable association with stem 86 thereby securing garment rail 88 in a generally horizontal orientation above deck assembly 42 such that garment rail 88 can be used for hanging engagement of apparel, apparel cases, or the like, therewith.

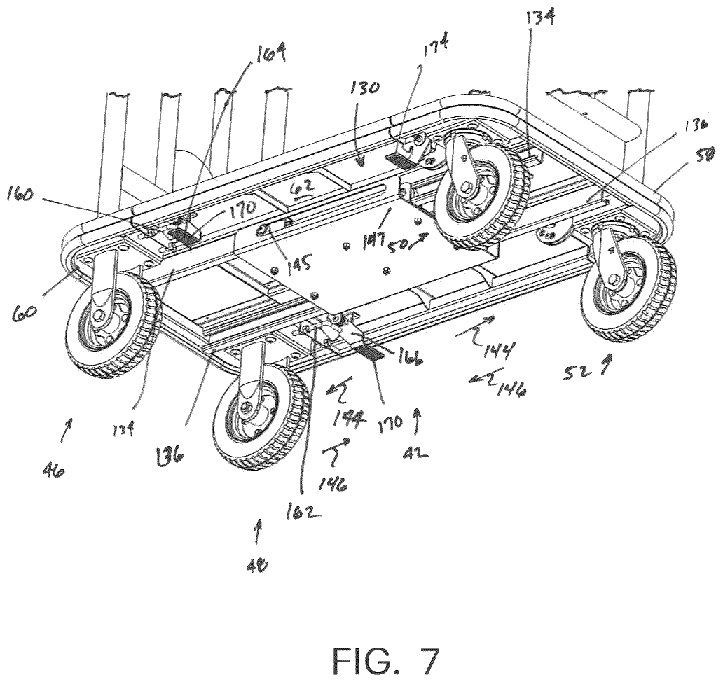

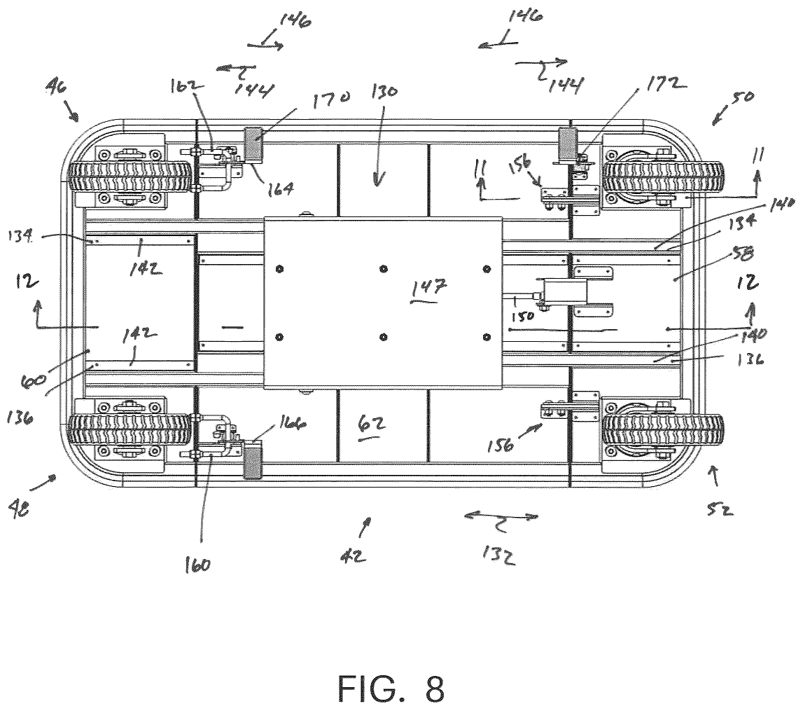

Referring to FIGS. 7 and 8, and turning generally to the underside of bellman cart assembly 40, caster assemblies 46, 48, 50, 52 are secured to respective end portions 58, 60 of deck assembly 42 and facilitate rollable transport of bellman cart assembly 40 when oriented in both the use or stowed/stored/collapsed configurations. It is appreciated that caster assemblies 46, 48, 50, 52 may be provided as fixed orientation caster assemblies (caster assemblies constructed to roll in fore and aft directions) and/or caster assemblies that are rotatable relative to a vertical axis to facilitate turning and or steerage of bellman cart assembly 40 during transport thereof and combinations thereof. Plurality of casters 46, 48, 50, 52 are disposed proximate an outermost radial edge of deck assembly 42 and support bellman cart assembly 40, whether loaded, empty, in the “use” configuration, or when in the stored/stowed/collapsed orientations and are positioned to facilitate rollable transport thereof and in a manner that mitigates tippage of bellman cart assembly 40.

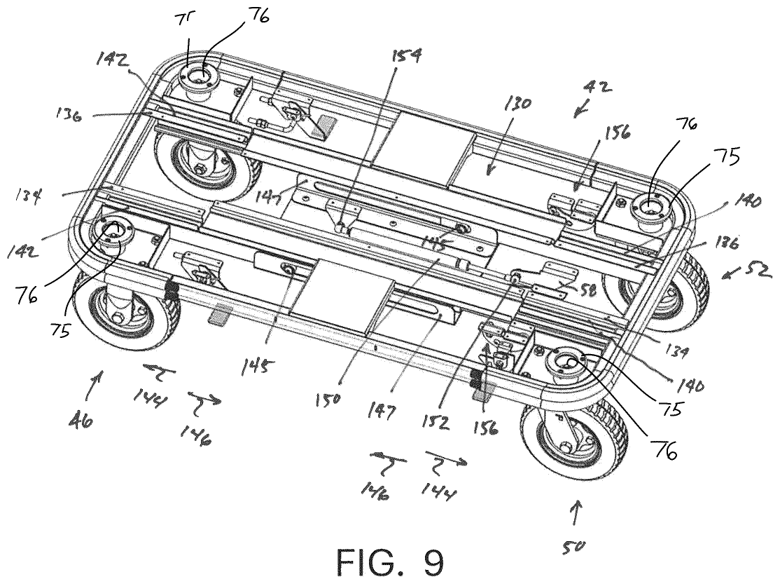

Referring to FIGS. 7-9 and 20, a slide or rail assembly 130 is secured to respective end portions 58, 60 of deck assembly 42 of bellman cart assembly 40 and extends along an underside thereof. As alluded to above, rail assembly 130 is constructed to accommodate the longitudinal translation of deck end portions 58, 60 relative to one another along the opposing longitudinal directions, indicted by arrow 132 (FIG. 8) during translation of bellman cart assembly 40 between the use and stored/stowed/collapsed configurations. Rail assembly 130 includes a first set of rails 134 and a second set of rails 136 that extend along direction 132 and are secured to respected end portions 58, 60 of deck assembly 42. Each set of rails 134, 136 includes a first rail section 140 that is secured to first deck portion 58 of deck assembly 42 and a second rail portion 142 that is attached to second deck portion 60 of deck assembly. Each set of rails 134, 136 may include a plurality of rollers or the like and one or more internal rails constructed to support the plurality of rollers without interfering with and otherwise configured to facilitate a smooth slidable association of the respective rail sections 140, 142 attached to the respective deck end portions 58, 60.

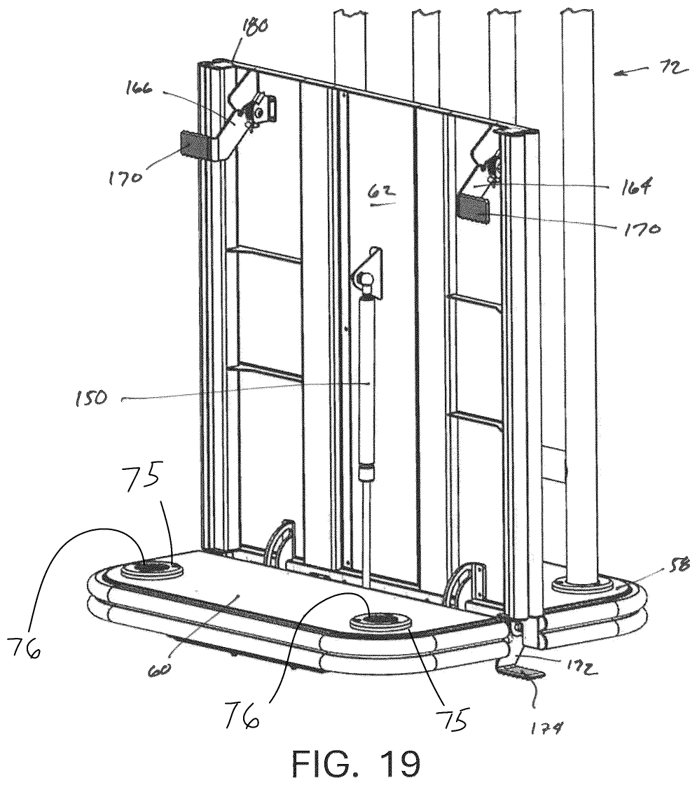

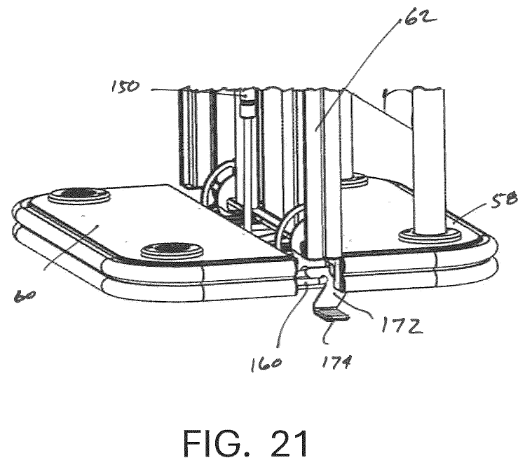

Respective rail portions 140, 142 of respective set of rails 134, 136 slideably cooperate with one another and/or interstitial rollers 145 and/or interstitial rails 147 so as to be selectively slidable along direction 132 to accommodate outward longitudinal translation, indicated by arrows 144, of first deck end portion 58 relative to second deck end portion 60 and inward longitudinal translation, indicated by arrows 146, of first deck end portion 58 relative to second deck portion 60 as bellman cart assembly 40 is transitioned between the in-use orientation as shown in FIG. 1 and a collapsed or stored orientation as disclosed further below with respect to FIGS. 16-21. As disclosed further below, when it is desired to configure bellman cart assembly 40 in the stowed/stowed/collapsed or non-use configuration, center deck portion 62 of deck assembly 42 is rotated out of alignment with respective end portions 58, 60 of deck assembly 42 and garment rail 88 is disengaged from stem 86 and rotated toward stem 84 to accommodate the longitudinal translation of first deck end portion 58 relative to second deck portion 60 and the slidable collapse or overlapping orientation of rail assembly 130. It is further appreciated that rail assembly 130 may include one or more biasing devices configured to assist with the slideable extension and/or retraction of rail assembly 130 during conversion of bellman assembly 40 between the use and collapsed or stowed configurations.

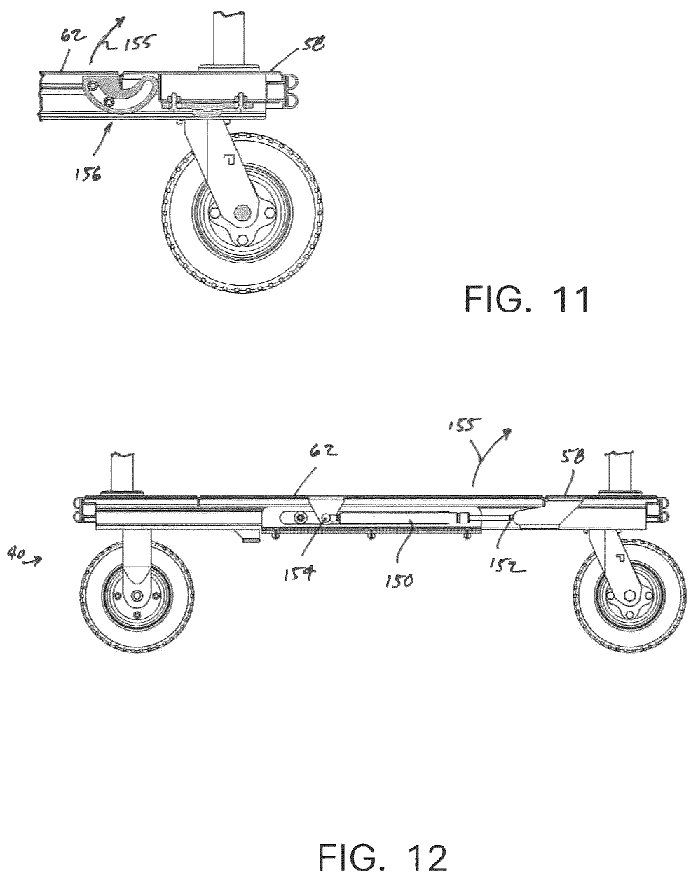

Referring to 8-12, a biasing assembly or device 150, such as a gas shock or the like, includes a first end 152 that is pivotably attached to first deck end portion 58 and a second end 154 that is pivotably attached to center deck portion 62. In a preferred embodiment, biasing device 150 is provided as a gas spring assembly constructed to impart an upwardly directed rotational bias, indicated by arrow 155 (FIG. 12), of center portion 62 of deck assembly 42 relative to first deck end portion 58 when it is desired to collapse bellman cart assembly 40 or convert bellman cart assembly 40 from the in-use configuration shown in FIG. 1. It is appreciated that the directional bias imparted by biasing device 150 may be configured to impart an upwardly directed bias, a downwardly directed bias, and a fixed or variable degree of bias as a function of the construction of biasing device 150 and/or the relative mounting locations associated with the biasing device when oriented in the upwardly extending orientation or the horizontally oriented orientation. It is further appreciated that biasing device 150 and center deck portion 62 may be configured and connected to one another such that motion of the center deck portion 62 from any orientation relative to the first deck portion 58 may or may not require user interaction with center deck portion 62.

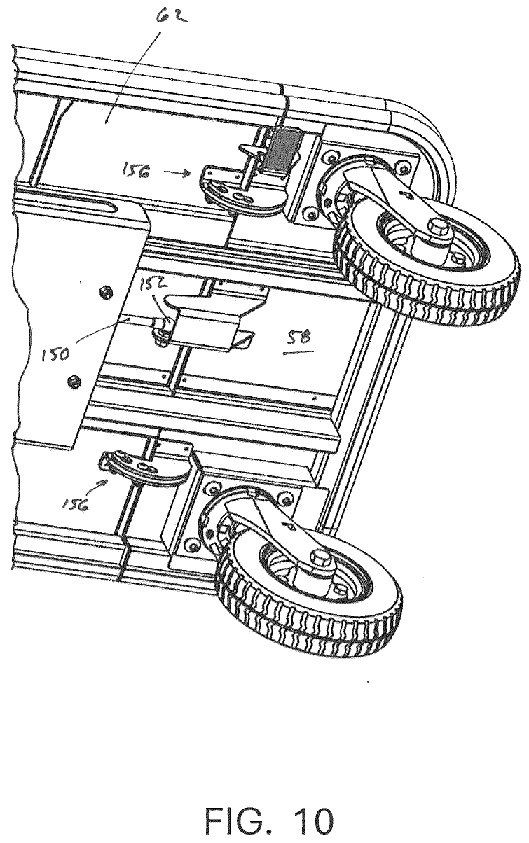

Regardless of the relative contribution and/or direction of biasing operation associated with biasing device 150 relative to movement of center deck portion 62 relative to first deck end portion 58, and referring to FIGS. 10-12, one or more hinge or pivot assemblies 156 pivotably connect center deck portion 62 to first deck end portion 58 and facilitate the rotational translation of center deck portion 62 relative to first deck end portion 58 when desired. In a preferred embodiment, respective pivot assemblies 156 are formed of bypassing metal plates that are preferable welded to respective portions of the deck to which they are respectively secured. Such a consideration provides a robust pivotable connection, a secure mechanical connection to the underlying structures to which respective portions of the pivot assembly are secured, and mitigates twisting or racking of the pivot assembly during operation thereof. As disclosed further below, respective latch assemblies facilitate the selective secure and movable interaction between center deck portion 62 and respective first and second deck end portions 58, 60 of deck assembly 42 to allow the selective translation of center deck portion 62 between the generally horizontal orientation shown in FIGS. 1-12; wherein center deck portion 62 is generally aligned with the longitudinal direction of respective deck end portions 58, 60 and extends securely therebetween during use of bellman cart assembly 40; and a generally upwardly directed orientation, as shown in FIGS. 16-18, for storage of bellman cart assembly 40. In a preferred embodiment, user interaction with each of latches 164, 166 is required to effectuate disengagement of center deck portion 62 from secure interaction with deck second end portion 60. Such a consideration mitigates unintended or inadvertent dissociation of a free end of center deck portion 62 from secure interaction with deck second end portion 62 via inadvertent contact with only one respective lever 170.

Referring initially to FIGS. 7 and 14, second end portion 60 of deck assembly 42 includes one or more catches 160, 162 that are constructed to selectively engage respective latches 164, 166 secured to the underside of center deck portion 62 when center deck portion 62 is horizontally oriented or oriented in longitudinal alignment with respective first end deck portion 58 and second end deck portion 60. At least one of latches 164, 166 includes a lever 170 that is accessible to the user to effectuate dissociation of respective latches 164, 166 from respective catches 160, 162 when desired. When respective latches 164, 166 are engaged with respective catches 160, 162, center deck portion 62 is secured to second deck end portion 60 via the cooperation of latches 164, 166 and catches 160, 162 and center deck portion 62 is oriented in a generally horizontal orientation.

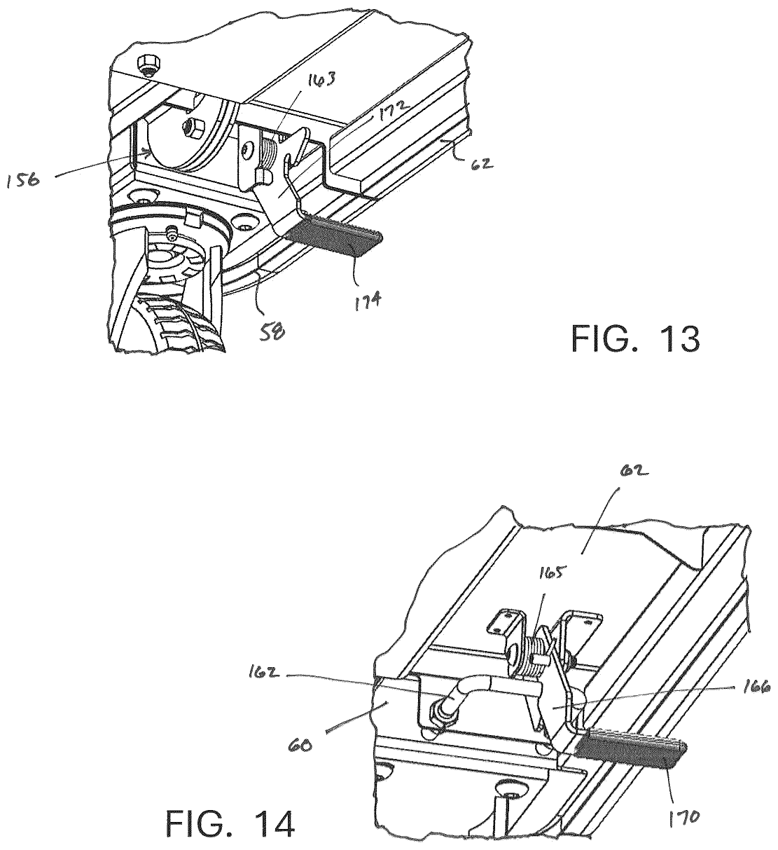

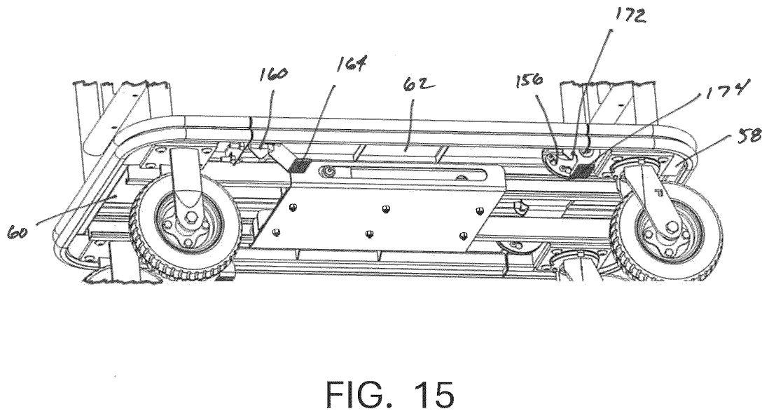

As shown in FIG. 13, first deck end portion 58 of deck assembly 42 also includes at least one latch 172 having a lever 174. As disclosed further below, latch 172 engages respective catch 160 when bellman cart assembly 40 is oriented in a stowed configuration as shown in FIG. 16 and operates to maintain the generally close proximity of first and second deck end portions 58, 60 when bellman cart assembly 40 is oriented in the stowed or collapsed position. Such a consideration mitigates undesired translation or relative positional separation of the first and second deck end portions 58, 60 during rolling transport of respective bellman cart assemblies 40 when the bellman cart assemblies are oriented in a stowed configuration.

Regardless of the relative in-use or stowed orientation of the respective bellman cart assemblies 40, when respective ones of latches 164, 166, 172 engage catches 160, 162, the cooperation of the respective latch 164, 166, 172 with the respective catch 160, 162 operates to bias the catch into engagement with the respective latch 164, 166, 172 until user interaction with the respective lever associated therewith to effectuate the selective disengagement therebetween. Preferably, one of more of respective latches 164, 166, 172 include one or more biasing devices, such as springs or the like (FIGS. 13-163; FIGS. 14-165) that are configured to bias the respective latch 164, 166, 172 into secure engagement with a respective catch 160, 162 when the respective latch is positioned adjacent thereto. As disclosed further below, when oriented in the stowed configuration such that center deck portion 62 is oriented in a generally upward extending orientation relative to respective deck end portions 58, 60, and respective deck end portions 58, 60 are translated toward one another to reduce the spatial footprint of bellman cart assembly 40, latch 172 associated with first deck end portion 58 is positioned proximate to and engages catch 162 associated with second deck end portion 60 such that engagement of latch 172 with catch 162 secures bellman card assembly 40 in the collapsed, stowed, or stored orientation as shown in FIGS. 16-18 until user interaction with lever 174 initiates disengagement of latch 172 from catch 162.

Referring to FIGS. 1 and 16-21, when use of bellman cart assembly 40 is no longer desired or required, or storage or collapsing of the bellman cart assembly 40 is desired, bellman cart assembly 40 can be oriented in a stowed/stored/collapsed or non-use configuration 179 as shown in FIGS. 16-18. When intended to be collapsed, user interaction with operator 106 allows selective disengagement of garment rail 88 from stem 86 of tube assembly 74 associated with second deck end portion 60 such that garment rail 88 can be rotated in direction 114 to be generally aligned with stem 84 of tube assembly 72 associated with deck first end portion 58. User interaction with one or more of levers 170 (FIG. 14) associated with one or more of latches 164, 166 secured to the underside of center deck portion 62 effectuates disengagement of the respective latch 164, 166 from the respective catch 162 associated with deck second end portion 60 and renders deck center portion 62 rotational in a generally upward direction relative to the generally horizontal orientation thereof when bellman cart assembly 40 is configured in the in-use orientation as shown in FIG. 1. Biasing device 150 assists in the translation of a free end 180 of center portion 62 of deck assembly 42 in a generally upward and rearward rotational direction toward tube assembly 72 associated with first deck end portion 58. As the free end 180 of center deck portion 62 rotates in a generally upward vertical direction relative to first and second deck end portions 58, 60, user interaction with respective tube assemblies 72, 74 allows inward lateral translation, indicated by arrows 146, of first deck end portion 58 relative to second deck end portion 60 as the discrete rail portions of rail assembly 130 telescopically collapse and generally overlie one another (FIG. 20) in a generally horizontal plane.

When rail assembly 130 is fully collapsed or retracted as shown in FIG. 20, latch 172 associated with first deck end portion 58 automatically engages catch 162 thereby securing first deck end portion 58 relative to second deck end portion 60 in the collapsed stowed or stowed configuration. When intended to be deployed, user interaction with lever 174 allows latch 172 to be disengaged from catch 162 such that respective deck end portions 58, 60 can be translated in the outward lateral directions via extension of rail assembly 130 until full extension thereof and such that center deck portion 62 can be rotated in a generally downward direction and into generally planar alignment with respective deck end portions 58, 60. When disposed thereat, one of more of latches 164, 166 associated center deck portion 62 automatically engage respective catches 160, 162 of second deck end portion 62 thereby securing deck assembly 42 in the in-use configuration. Upward rotation of garment rail 88 relative to stem 84 and selective user interaction with operator 106 allows operator 106 to be selectively engaged with stem 86 thereby securing garment rail 88 in the generally horizontal in-use orientation wherein garment rail 88 extends over luggage cavity 80 between deck assembly 42 and tube assemblies 72, 74.

As disclosed above, bellman cart assembly 40 can be efficiently and expeditiously translated between an in-use configuration and a stored or collapsed configuration in response to user desires or requirements. The automatically operable and translation assistance associated with the variety of catches, latches, and biasing devices requires minimal user effort to effectuate translation of bellman cart assembly 40 between the use and collapsed configurations. It is further appreciated that respective levers 166, 170, 174 may be manually manipulated by interaction with either of a hand or a foot of the user. Whether operated by hand or by foot, manual interaction with the respective levers 166, 170, 174 associated with the variety of catches and latches associated with deck assembly 42 allows the user to collapse or expand bellman cart assembly 40 in a manner wherein the various operations are intuitive with simple visual inspection of the bellman cart assembly. When in the stored configuration, plurality of caster assemblies 46, 48, 50, 52 remain sufficiently spaced to accommodate customary operation thereof and mitigate tippage of bellman cart assembly 40 when oriented in the stowed configuration even during rolling transport thereof.

While bellman cart assembly 40 remains transportable via the plurality of casters 46, 48, 50, 52 when in both the in-use and collapsed configurations, when oriented in the stored or collapsed configuration, bellman cart assembly 40 occupies considerably less space than the in-use configuration without requiring separation or disassembly of bellman cart assembly 40. When configured for use, the majority of the top plan view or vertical footprint defined by bellman cart assembly 40 is defined by deck assembly 42 and has a longitudinal length of approximately 42 inches and a depth or width of 24 inches such that the vertical footprint of assembly 40 is slightly over 1000 square inches. When collapsed or oriented in a stowed configuration, bellman cart assembly 40 can be collapsed to a longitudinal length of approximately 20 inches whereas the depth or width of the assembly remains unchanged such that, when oriented in the stowed configuration, bellman cart assembly 40 can achieve a configuration wherein the cart assembly 40 occupies less than in-use configuration, is preferably less than 80% of the in-use configuration, is more preferably less than 50% of the in-use configuration, and is 500 square inches. Accordingly, when oriented in the stowed configuration, two bellman cart assemblies 40 can be stored in the same space commonly occupied by one non-collapsed bellman cart. In addition to increasing the storage capacity relative to non-collapsible bellman cart assembly, bellman cart assemblies 40 can also be rollably transported through tighter quarters than non-collapsible cart assemblies.

Therefore, one embodiment of the invention that is usable or combinable with other features, aspects, or objects of any of the embodiments includes a bellman cart assembly that is constructed to achieve an in-use or deployed orientation and a stowed or collapsed configuration when desired. The bellman cart assembly includes a deck or deck assembly that is defined by a first end portion, a second end portion, and a center portion that is pivotably connected to a respective one of the first end portion or the second end portion of the deck. A tube assembly extends in a generally upward direction from each of the first end portion and the second end portion of the deck. A garment rail extends between the tube assembly associated with the first and second end portions of the deck. A plurality of casters are secured to the deck and generally disposed under a respective one of the first end portion and the second end portion thereof. A hinge arrangement is connected between the center portion of the deck and the respective one of the first end portion and the second end portion such that the center portion is selectively rotatable relative thereto. A first guide rail is attached to the first end portion and a second guide rail is attached to the second end portion such that the first guide rail and the second guide rail are slidable relative to one another to allow translation of the first end portion of the deck relative to the second end portion of the deck to manipulate a distance therebetween. A spring piston is connected between the center portion of the deck and the respective one of the first end portion and the second end portion and configured to bias the center portion out of alignment with the first end portion and the second end portion of the deck, such that, when the center portion of deck is disposed out of alignment with the first and second end portions of the deck, the deck is compressible to reduce a footprint of the bellman cart assembly when storage thereof is desired.

Another embodiment of the invention that is usable or combinable with one of the more of the discrete features, aspects, objects, or other embodiments includes a method of forming a collapsible bellman cart assembly. The method includes providing a deck that is defined by a first end portion, a second end portion, and a center portion that is pivotably connected to the first end portion. A cage assembly is provided and that is defined by a first cage end that extends from the first end portion of the deck, a second cage end that extends from the second end portion of the deck, and a garment rail that extends between the first cage end and the second cage end and is pivotable relative to the first cage end and removably cooperates with the second cage end. A rail assembly is provided that connects the first end portion of the deck to the second end portion of the deck such that the first end portion of the deck and the second end portion of the deck are movable between respective extended and retracted positions relative to one another. When the garment rail is removed or disengaged from the second cage end and subsequently pivoted relative to the first cage end; and the center portion of the deck is pivoted out of alignment with the first end portion and the second end portion of the deck; the first and second end portions of the deck are rendered translatable relative to one another such that the bellman cart assembly can achieve respective extended and retracted positions.

A further embodiment of the invention that is useable or combinable with one or more of the above features, objects, aspects, or embodiments includes a bellman cart assembly having a deck assembly that is defined by respective opposing end portions and a center portion that is pivotably connected to a respective one of the opposing end portions. A respective tube assembly extends in a generally upward direction from each of the respective opposing end portions of the deck assembly and a garment rail extends between the respective tube assemblies. The garment rail is pivotably connected to one of the respective tube assemblies and selectively removable and securable to the other of the respective tube assemblies. A plurality of casters are secured to the deck assembly and extend in a direction opposite the respective tube assemblies and facilitate rolling transport of the bellman cart assembly during both use and storage operations. A hinge connects the center portion of the deck assembly to the respective one of the opposing end portions to which the center portion is pivotably connected. A slide or rail assembly is secured to the deck assembly and operable to adjust a distance between the respective opposing end portions of the deck assembly. A biasing device is connected between the center portion of the deck assembly and a respective one of the opposing end portions to bias the center portion out of alignment with the opposing end portions of the deck assembly when storage or non-use of the bellman cart assembly is desired.

These and other aspects, objects, features, embodiments, and advantages of the invention will become apparent to those skilled in the art from the following claims. It should be understood, however, that the detailed description and the specific examples provided therein, while indicating preferred embodiments of the present invention, are given by way of illustration and not of limitation. Many changes and modifications may be made within the scope of the present invention without departing from the spirit thereof, and the invention includes all such modifications. Other features, objects, aspects, advantages, and embodiments of the invention are made apparent from the above description taken together with the drawings. It is further appreciated that the various features, aspects, objects, and advantages disclosed above are not mutually exclusive to the specific aspects or embodiments of the invention such that the various discrete features, aspects, objects, and advantages are usable and/or combinable with one another.

We claim:

1. A bellman cart assembly comprising:
a deck having a first end portion, a second end portion, and a center portion pivotable connected to a respective one of first end portion and the second end portion;
a tube assembly extending in an upward direction from each of the first end portion and the second end portion of the deck;
a garment rail extending between the tube assembly associated with the first end portion of the deck and the tube assembly associated with the second end portion of the deck;
a plurality of casters secured to the deck and generally disposed under a respective one of the first end portion and the second end portion;
a hinge arrangement connected between the center portion of the deck and the respective one of the first end portion and the second end portion such that the center portion is selectively rotatable relative thereto;
a first guide rail attached to the first end portion and a second guide rail attached to the second end portion wherein the first guide rail and the second guide rail are slidable relative to one another to allow translation of the first end portion of the deck relative to the second end portion of the deck to manipulate a distance therebetween; and
a spring piston connected between the center portion of the deck and the respective one of the first end portion and the second end portion and configured to bias the center portion out of alignment with the first end portion and the second end portion of the deck.

2. The bellman cart assembly of claim 1 wherein at least two of the plurality of casters are further defined as swivel casters.

3. The bellman cart assembly of claim 1 wherein the center portion is pivotably connected to the first end portion and a catch is attached to the second end portion of the deck.

4. The bellman cart assembly of claim 3 further comprising a latch attached to the center portion of the deck and configured to engage the catch when the center portion of the deck is aligned with the first end portion and the second end portion of the deck.

5. The bellman cart assembly of claim 4 wherein the latch further defines a lever.

6. The bellman cart assembly of claim 4 further comprising another latch attached to the first end portion of the deck that is selectively engageable with the catch when the first guide rail and the second guide rail are oriented in a retracted position.

7. The bellman cart assembly of claim 6 wherein the another latch further defines a lever.

8. The bellman cart assembly of claim 1 wherein the garment rail is pivotably connected to the tube assembly extending from the first end portion of the deck and removably cooperates with the tube assembly extending from the second end portion of the deck.

9. The bellman cart assembly of claim 1 wherein the garment rail is foldable into a space between the tube assembly extending from the first end portion of the deck and the tube assembly extending from the second end portion of the deck.

10. The bellman cart assembly of claim 1 further comprising a third guide rail and a fourth guide rail that are similar to the first guide rail and the second guide rail and such that the first and second guide rails and third and fourth guide rails are oriented on opposite lateral sides of a longitudinal centerline of the deck.

11. A method of forming a collapsible bellman cart assembly, the method comprising:
providing a deck defined by a first end portion, a second end portion, and a center portion that is pivotably connected to the first end portion;
providing a cage assembly that is defined by a first cage end that extends from the first end portion of the deck, a second cage end that extends from the second end portion of the deck, and a garment rail that extends between the first cage end and the second cage end and is pivotably connected to the first cage end and removably cooperates with the second cage end;
providing a rail assembly that connects the first end portion of the deck to the second end portion of the deck such that the first end portion of the deck and the second end portion of the deck are movable between an extended position and a retracted position; and
removing the garment rail from the second cage end and pivoting the garment rail relative to the first cage end and pivoting the center portion of the deck out of alignment with the first end portion and the second end portion of the deck and translating the first end portion of the deck toward the second end of the deck from the extended position toward the retracted position.

12. The method of claim 11 further comprising providing a catch associated with the second end portion of the deck.

13. The method of claim 12 further comprising providing a latch attached to the center portion of the deck and selectively engageable with the catch when the first and second end portions of the deck are oriented in the extended position.

14. The method of claim 13 further comprising providing another latch attached to the first end portion of the deck and selectively engageable with the catch when the first and second end portion of the deck are oriented in the retracted position.

15. The method of claim 14 further comprising providing at least one of the latch and the another latch with a lever that manipulates engagement of the at least one of the latch and the another latch with the catch.

16. The method of claim 11 further comprising providing a biasing device that biases the center portion of the deck toward at least one of into alignment with and out of alignment with the first end portion and second end portion of the deck.

17. A bellman cart assembly comprising:
a deck assembly defined by respective opposing end portions and a center portion that is pivotably connected to a respective one of the opposing end portions;
a respective tube assembly extending in an upward direction from each of the respective opposing end portions of the deck assembly;
a garment rail that extends between the respective tube assemblies and is pivotably connected to one of the respective tube assemblies and selectively removable and securable to an other of the respective tube assemblies;
a plurality of casters secured to the deck assembly and extending in a direction opposite the respective tube assemblies;
a hinge connected between the center portion of the deck assembly and the respective one of the opposing end portions to which the center portion is pivotably connected;
a rail assembly secured to the deck assembly and operable to adjust a distance between the respective opposing end portions of the deck assembly; and
a biasing device connected between the center portion of the deck assembly and a respective one of the opposing end portions and configured to bias the center portion out of alignment with the opposing end portions of the deck assembly.

18. The bellman cart assembly of claim 17 further comprising a latch assembly constructed to selectively secure the deck assembly in at least one of an extended position and a retracted position.

19. The bellman cart assembly of claim 18 wherein the latch assembly is further defined as a latch portion and a catch portion and the catch portion is biased into engagement with the latch portion.

20. The bellman cart assembly of claim 17 wherein the biasing device is further defined as a shock assembly that is configured to bias the center portion of the deck assembly out of alignment with opposing respective end portions of the deck assembly.
